(19) United States
(12) Patent Application Publication
(10) Pub. No.: US 2008/0135567 A1
(43) Pub. Date: Jun. 12, 2008

(54) Receptacle Positioning Apparatus

(76) Inventor: John McGee, Richmond, VA (US)

Correspondence Address: BARNES & THORNBURG LLP, 750-17TH STREET NW, SUITE 900, WASHINGTON, DC, 20006-4675, US

(21) Appl. No.: 11/955,162

(22) Filed: Dec. 12, 2007

Related U.S. Application Data
(60) Provisional application No. 60/874,275, filed on Dec. 12, 2006.

(51) Int. Cl. B65F 1/14; A47B 97/00

(52) U.S. Cl. 220/694; 16/404; 428/543

(57) ABSTRACT

An apparatus for positioning a movable object with respect to an immovable object is described. The apparatus includes a body with a top surface, a bottom surface, a first surface extending between the top surface and the bottom surface for engaging the movable object, and a second surface extending between the top surface and the bottom surface for engaging the immovable object, the second surface being opposed to the first surface. At least first and second contact points are defined by the first surface. At least third and fourth contacts points are defined by the second surface. The first and second contact points are separated from one another by a first distance and the third and fourth contact points are separated from one another by a second distance. The first distance is less than or equal to the second distance.

### CROSS-REFERENCE(S) TO RELATED APPLICATION(S)

This patent application relies for priority on U.S. Provisional Patent Application Ser. No. 60/874,275, entitled “Trash Can Spacer,” which was filed on Dec. 12, 2006, the contents of which are incorporated herein by reference.

### FIELD OF THE INVENTION

The invention concerns an apparatus that cooperates with a receptacle, such as a waste receptacle or garbage can. The apparatus positions the waste receptacle a predetermined distance from an immovable obstacle, such as a wall.

### DESCRIPTION OF THE RELATED ART

Waste receptacles, including trash cans, are available to consumers in a wide variety of different styles.

One common style of waste receptacle or garbage can is commonly referred to as a step-pedal type. For this particular waste receptacle, the user steps on a pedal, typically on the front of the waste receptacle. Application of pressure to the pedal causes the top of the receptacle to open.

Each time a user applies pressure to the step-pedal, however, the waste receptacle has a tendency to move or slide in a direction away from the user. In most cases, this usually means that the waste receptacle moves closer to an adjacent wall.

As should be appreciated by the typical user of these types of waste receptacles, when the lid of the receptacle opens and the receptacle is very near to an adjacent wall, the lid may hit the adjacent wall, leaving a mark or otherwise damaging the adjacent wall.

Depending upon the style of the particular waste receptacle, if the receptacle slides to a position where it abuts the adjacent wall, it is also possible that the lid may be prevented from opening because of the juxtaposition of the receptacle and the wall.

These failings with respect to waste receptacles remain unaddressed.

### SUMMARY OF THE INVENTION

It is at least one aspect of the invention to resolve one or more of the failings noted with respect to waste receptacles in the prior art.

In this light, the invention provides an apparatus that maintains the waste receptacle at a distance from the adjacent wall to permit the receptacle to open properly without any portion of the waste receptacle impacting or damaging the wall.

The invention prevents a waste receptacle from sliding toward an adjacent wall.

In one embodiment of the invention, an apparatus is provided for positioning a movable object with respect to an immovable object. The apparatus includes a body defining a top surface and a bottom surface. A first surface extends between the top surface and the bottom surface for engaging the movable object. A second surface extends between the top surface and the bottom surface for engaging the immovable object. The second surface is opposed to the first surface. At least first and second contact points are defined by the first surface and at least third and fourth contacts points are defined by the second surface. The first and second contact points are separated from one another by a first distance. The third and fourth contact points are separated from one another by a second distance. The first distance is less than or equal to the second distance, thereby discouraging skewing of the body when forces of disproportionate magnitudes are applied to the first and second contact points.

In another embodiment of the invention, the first distance is less than the second distance.

For purposes of the invention, the first and second contact points may define lateral endpoints of the first surface and the third and fourth contact points may define lateral endpoints of the second surface. Other variations are also contemplated.

In other embodiments, a third surface extends between the first surface, the second surface, the top surface, and the bottom surface. In addition, a fourth surface extends between the first surface, the second surface, the top surface, and the bottom surface.

In one contemplated embodiment, the first and second surfaces are curved inwardly toward a first centerline defined therebetween. Additionally, the third and fourth surfaces are curved outwardly from a second centerline defined therebetween.

As noted, it is contemplated that the immovable object is a waste receptacle and the immovable object is an opposing surface. It is also contemplated that the opposing surface is a wall.

The apparatus of the invention may have one of a number of different cross-sections. For example, the body may be hollow. The body may be U-shaped in cross-section. Alternatively, the body may be H-shaped in cross-section. Further still, the body may be solid in cross-section.

In other embodiments, the apparatus may include at least one projection disposed on the bottom surface of the body. That projection may be conically-shaped to releasably engage piles of a carpet.

The apparatus of the invention also may include at least one foot disposed on the bottom surface of the body. If so, the foot may be an elastomeric material, such as rubber.

Other aspects of the invention will be made apparent from the description that follows and will be appreciated by those skilled in the art.

### BRIEF DESCRIPTION OF THE DRAWINGS

The invention is described in connection with the drawings appended hereto, in which:

FIG. 1 is a side view illustration of a waste receptacle without the invention, illustrating at least one failing with respect to the prior art;

FIG. 2 is a side view illustration of a first embodiment of the invention disposed next to the waste receptacle to position the waste receptacle with respect to the adjacent wall;

FIG. 3 is a top view of the first embodiment of the invention, illustrating the placement of the invention between a waste receptacle and a wall;

FIG. 4 is a top, plan view of the first embodiment of the invention;

FIG. 5 is a cross-sectional side view of the first embodiment of the invention taken along the line 5-5 in FIG. 4;

FIG. 6 is a perspective top view of the first embodiment of the invention;

FIG. 7 is a perspective rear view of the first embodiment of the invention;

FIG. 8 is a top, plan view of a second embodiment of the invention;

FIG. 9 is a cross-sectional side view of the second embodiment of the invention, taken along line 9-9 in FIG. 8;

FIG. 10 is a perspective top view of the second embodiment of the invention;

FIG. 11 is a perspective rear view of the second embodiment of the invention;

FIG. 12 is a cross-sectional side view of a third embodiment of the invention, this embodiment being a first variation of the second embodiment;

FIG. 13 is a cross-sectional side view of a fourth embodiment of the invention, this embodiment being a second variation of the second embodiment;

FIG. 14 is a top plan view of a fifth embodiment of the invention;

FIG. 15 is a top plan view of a sixth embodiment of the invention;

FIG. 16 is a top plan view of a seventh embodiment of the invention;

FIG. 17 is a top plan view of an eighth embodiment of the invention;

FIG. 18 is a top plan view of a ninth embodiment of the invention;

FIG. 19 is a top plan view of a tenth embodiment of the invention;

FIG. 20 is a top plan view of an eleventh embodiment of the invention;

FIG. 21 is a top plan view of a twelfth embodiment of the invention;

FIG. 22 is a top plan view of a thirteenth embodiment of the invention;

FIG. 23 is a cross-sectional side view of a fourteenth embodiment of the invention;

FIG. 24 is a cross-sectional side view of a fifteenth embodiment of the invention;

FIG. 25 is a cross-sectional side view of a sixteenth embodiment of the invention;

FIG. 26 is a cross-sectional side view of a seventeenth embodiment of the invention;

FIG. 27 is a cross-sectional side view of an eighteenth embodiment of the invention;

FIG. 28 is a cross-sectional side view of a nineteenth embodiment of the invention; and

FIG. 29 is a top plan view of a twentieth embodiment of the invention.

### DETAILED DESCRIPTION OF EMBODIMENT(S) OF THE INVENTION

Various aspects of the invention will now be described. As should be appreciated by those skilled in the art, a discussion of a particular embodiment of the invention should not be understood as a limitation on the scope of the invention. The various embodiments discussed herein are meant to be exemplary. There are numerous equivalents and variations on the embodiments discussed herein that are intended to be encompassed by the invention, as should be appreciated by those skilled in the art.

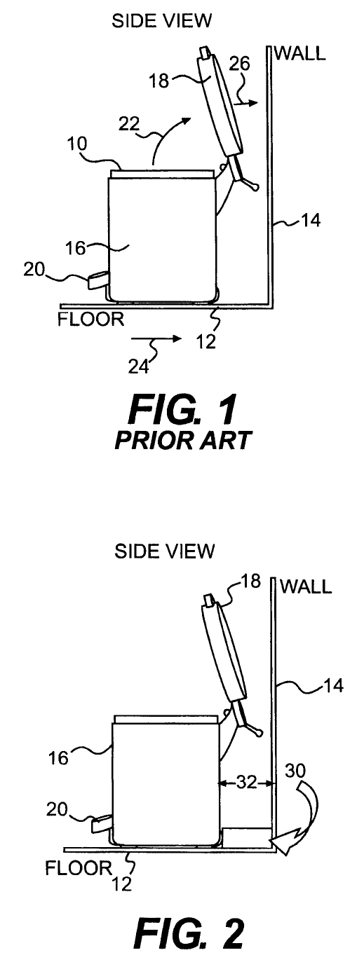

FIG. 1 illustrates a typical prior art example of a waste receptacle 10 placed on a floor 12, adjacent to a wall 14. The waste receptacle 10 includes a container portion 16 and a lid 18 hingedly attached to the container portion 16. A step pedal 20 is provided on a front of the waste receptacle 10 to open the lid 18. As should be appreciated by those skilled in the art, when pressure is applied to the foot pedal 20, the lid 18 opens in the direction of the arrow 22. As also may be appreciated by those skilled in the art, application of a force to the foot pedal 20 also has the tendency to push the waste receptacle 10 in the direction of the arrow 24 towards the wall 14. If the waste receptacle 10 is close enough to the wall 14, when the foot pedal 20 is actuated, the lid 18 may open and impact with the wall 14, as indicated by the arrow 26.

FIG. 2 illustrates one contemplated placement position for the apparatus 30 of the present invention. The apparatus 30 is also referred to as a “spacer” in this disclosure. The apparatus 30 of the invention is positioned between the waste receptacle 10 and the wall 14 to maintain the waste receptacle 10 and the wall 14 in a fixed relationship with respect to one another. As should be apparent, the distance 32 maintained between the waste receptacle 10 and the wall 14 is greater that the arcuate distance traversed by the lid 18 when pressure is applied to the foot pedal 20, thereby presenting the lid 18 from impacting with the wall 14.

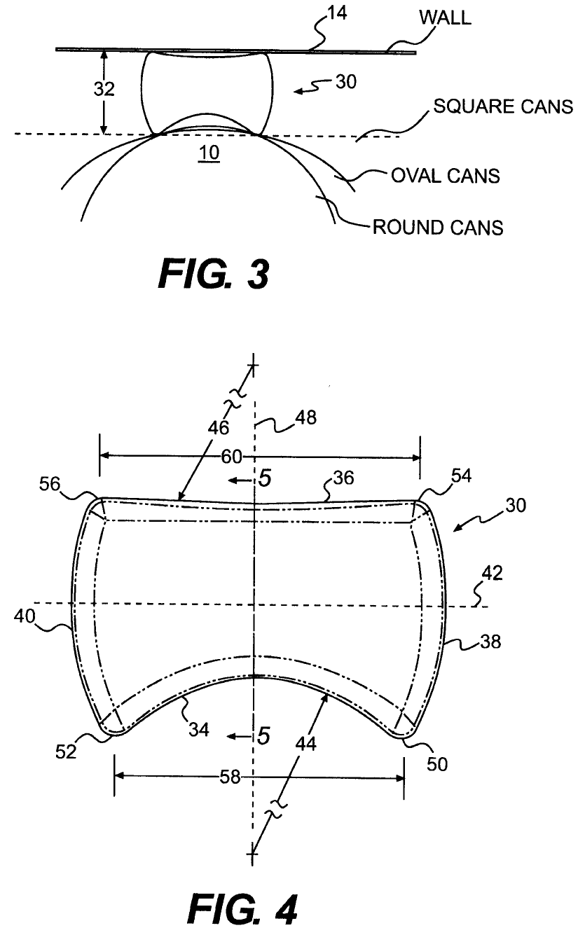

FIG. 3 illustrates the distance 32 created by the apparatus 30 when positioned between the wall and a waste receptacle 10. FIG. 3 also illustrates that the apparatus 30 is intended to cooperate with waste receptacles 10 in a wide variety of shapes and sizes including, but not limited to, square, oval, and round waste receptacles 10.

FIG. 4 is a top plan view of a first embodiment of the apparatus 30 of the invention. This embodiment is the same as the apparatus 30 illustrated in FIG. 3. The apparatus 30 includes a first side 34 and a second side 36, which are opposed to one another. The apparatus 30 also includes a third side 38 and a fourth side 40, which are opposed to one another.

As is apparent from FIG. 4, the first side 34 curves inwardly toward a first centerline 42 between the first side 34 and the second side 36. In FIG. 4, the first surface has a continuous curve that is defined by a first radius of curvature 44. Similarly, the second surface 36 also curves inwardly toward the first centerline 42, albeit to a smaller extent than the first surface 34. As with the first surface 34, the second surface has a constant curvatures defined along a second radius of curvature 46. As should be appreciated by those skilled in the art, the illustrated first and second radii of curvatures 44, 46 are not required to practice the invention. To the contrary, any curvature may be employed without departing from the scope of the invention. Moreover, as will be emphasized in connection with FIGS. 14-22, the first and second surfaces 34, 36 may take any number of a wide variety of different shapes without departing from the scope of the invention.

Also with reference to FIG. 4, it is noted that the third and fourth surfaces 38, 40 curve outwardly from a second centerline 48 the body of the apparatus 30. The exact curvatures of the third and fourth surfaces 38, 40 are not critical to operation of the invention. Moreover, as with the first and second surfaces 34, 36, the third and fourth surfaces 38, 40 need not be curved but may take any number of different appearances. In addition, as should be appreciated by those skilled in the art, the third and fourth surfaces do not need to be symmetric about the second 48, although this encompasses the illustrated example.

FIGS. 3 and 4 also illustrates that the first surface 34 defines a first contact point 50 and a second contact point 52. Similarly, the second surface 36 defines a third contact point 54 and a fourth contact point 56. The first and second contact points 50, 52 are separated from one another by a first distance 58. The third and fourth contact points 54, 56 are separated from one another by a second distance 60. In this embodiment of the apparatus 30, the first distance 58 is less than the second distance 60. However, it is contemplated that the first distance 58 may be the same as the second distance 60.

For the illustrated embodiment, the first distance 58 is less than the second distance 60. Of course, the apparatus 30 may be used in a reverse orientation, if preferred by the user. When positioned in a reverse orientation, the apparatus 30 is rotated 180° from the orientation illustrated in FIG. 3. As such, the first contact point 50 would become the fourth contact point 56 and the second contact point 52 would become the third contact point 54 and so on. In the reverse orientation, the first distance 58 would be larger than the second distance 60.

Continuing with reference to FIGS. 3 and 4, the apparatus 30 in intended for use such that the first and second contact points 50, 52 engage a surface of the waste receptacle 10 (i.e., the moveable object). The third and fourth contact points 54, 56 are intended to contact a surface of a wall 14 (i.e., an immovable object). The reason for this intended orientation is simple. Since the first distance 58 is less than the second distance 60, it is expected that application of a force against the apparatus 30 that is not perpendicular to the wall 14 might have a tendency to rotate or skew the apparatus 30. Therefore, it is anticipated that a larger second distance 60 will discourage rotation of the apparatus 30 about a center point, thereby adding stability to the apparatus 30.

In connection with the first, second, third, and fourth contact points 50, 52, 54, 56, a definitional observation is made. It is possible that the first surface 34 may have a curvature that is the same as the curvature of the exterior of the waste receptacle 10. In this case, the exterior surface of the waste receptacle 10 would have continuous contact with the apparatus 30 along the entire length of the first surface 34. As such, there would be an infinite number of points of contact between the waste receptacle 10 and the apparatus 30. Similarly, if the second surface 36 were linear, the second surface 36 would abut against a wall along its entire length. As a result, there would be an infinite number of contact points defined along the length of the second surface 36.

Building upon this conceptual analogy, the apparatus 30 (as well as the other embodiments discussed below) is constructed such that there are at least two contact points with the wall 14 and two contact points with the waste receptacle 10. It is believed that this design provides the most suitable and most stable arrangement for the apparatus 30 of the invention.

As may be appreciated by those skilled in the art, the discussion of the orientation of the apparatus 30 is intended to be explanatory only. As discussed above, it is contemplated that the apparatus 30 may be reversed in its orientation such that the third and fourth contact points 58, 60 engage the movable object 10 and that the first and second contact points 34, 36 engage a surface of the wall 14. While it is anticipated that this orientation is less likely to discourage rotation or skewing of the apparatus 30, it is believed that the reverse orientation also will perform the intended function of the invention.

FIG. 5 is a cross-sectional view of the apparatus 30 illustrated in FIGS. 3 and 4. The cross-section is taken along the line 5-5 in FIG. 4. In this figure, it is revealed that the apparatus 30 is U-shaped in cross-section, at least in this embodiment. As is also apparent, the apparatus has a top surface 62 and a bottom surface 64. As is also apparent, the transitions from the sides of the apparatus 30 to the top 62 are curved. While a curved transition is employed in this embodiment, the transitions from the sides to the top 62 may be rectilinear without departing from the scope of the invention. (See, e.g., FIG. 24.)

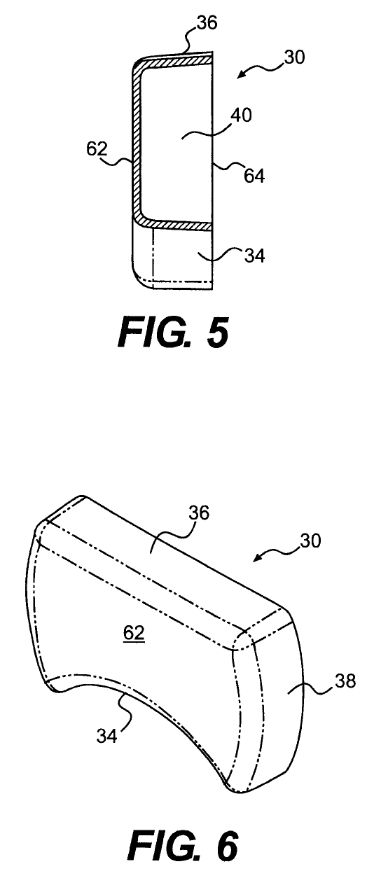

FIG. 6 is a perspective illustration of the top of the apparatus 30. The curved transitions from the side surfaces to the top surface 62 are also plainly evident in this illustration.

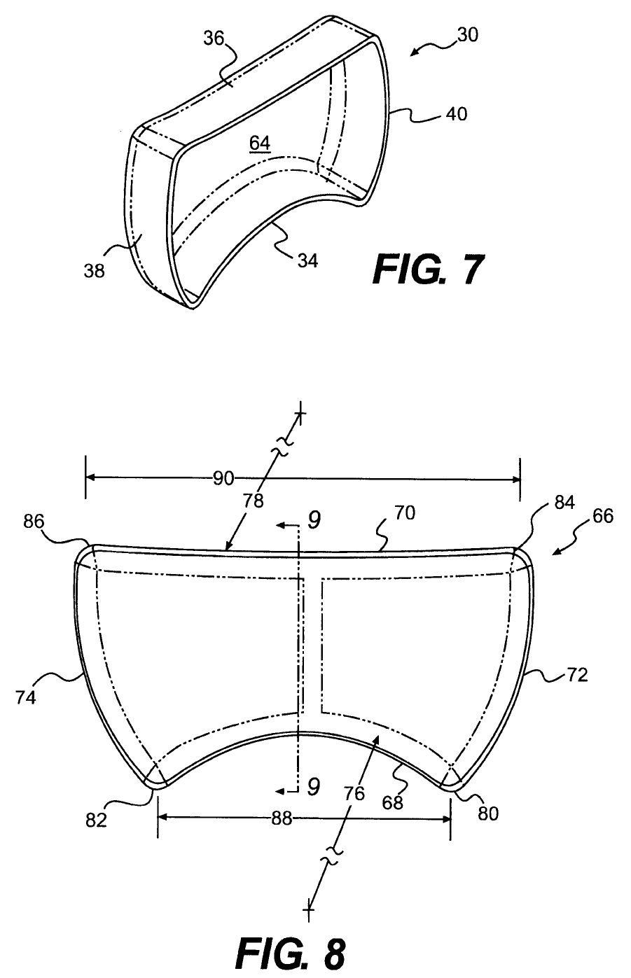

FIG. 7 is a perspective, rear view of the apparatus 30. The shape of the bottom surface 64 is more plainly evident in this illustration.

FIG. 8 is a top plan view of a second embodiment of the apparatus of the invention. Here, the apparatus is provided with reference number 66 to distinguish this embodiment from the first embodiment of the apparatus 30.

The apparatus 66 shares many similarities with the apparatus 30. The apparatus 66 includes a first side 68, an opposing second side 70, a third side 72, and an opposing fourth side 74. As with the apparatus 30, the first side 68 has a constant radius of curvature 76. The second side 70 also has a constant radius of curvature 78. The first side 68 defines at least a first contact point 80 and a second contact point 82. The third side 70 defines at least a third contact point 84 and a fourth contact point 86. The first and second contact points 80, 82 are separated from one another by a first distance 88. The third and fourth contact points 84, 86 are separated from one another by a second distance 90. As with the apparatus 30, the first distance 88 is less than or equal to the second distance 90. In the illustrated embodiment, the first distance 88 is less than the second distance 90.

The apparatus 66 differs from the apparatus 30 at least in its shape. As may be apparent from a comparison of FIG. 4 with FIG. 8, the second distance 90 in the apparatus 66 is slightly greater than the second distance 60 for the first apparatus 30. In addition, the first distance 88 for the apparatus 66 is smaller than the first distance 58 for the apparatus 30. These two embodiments emphasize that the actual shape and size of the various embodiments of the invention is not relevant to the practice of the invention. To the contrary, there are an infinite variety of different shapes and sizes that may be employed that are encompassed by the scope of the invention.

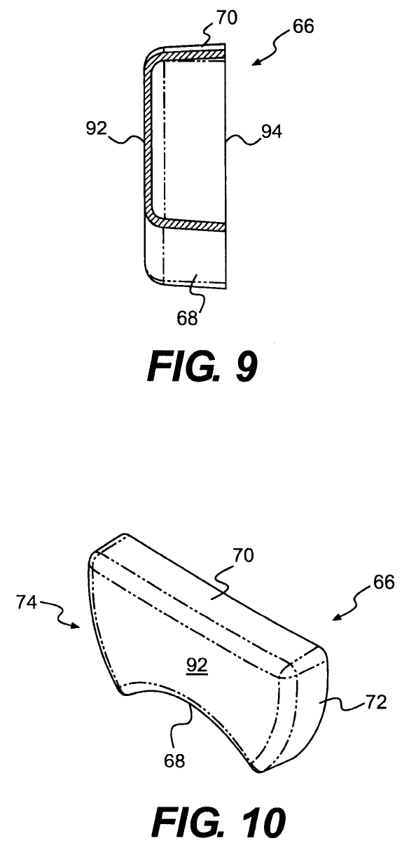

FIG. 9 provides a cross-sectional side view of the apparatus 66 illustrated in FIG. 8. The top surface 92 and the bottom surface 94 of the apparatus 66 are indicated.

FIG. 10 is a perspective top view of the apparatus 66.

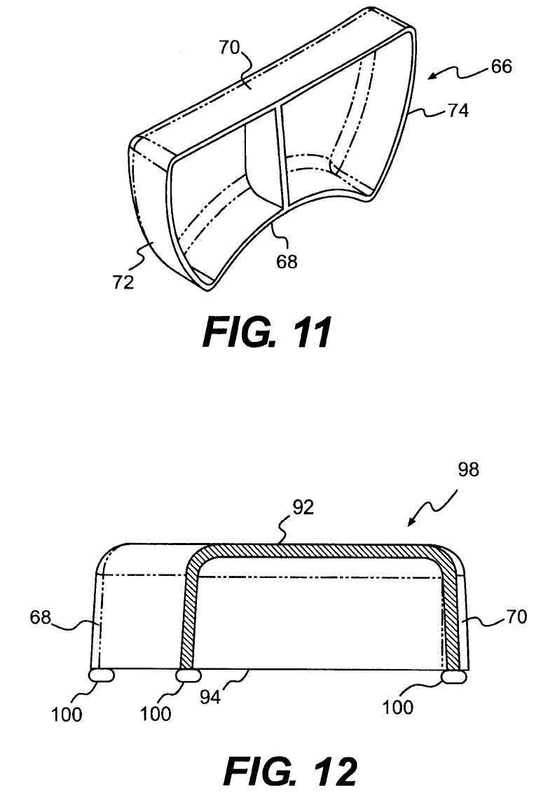

FIG. 11 is a perspective rear view of the apparatus 66. In this view, a reinforcing web 96 is shown. The reinforcing web 96 is added to illustrate that there are variations on embodiments of the invention that are intended to be encompassed by the invention. It is believed that one or more reinforcing webs probably will not be required in most commercial applications. However, certain materials may require the addition of one or more webs, as may be appreciated by those skilled in the art.

As for materials to construct the apparatuses 30, 66 of the present invention, any of a wide variety of materials including plastics, rubbers, elastomeric materials, metals, glass, composite materials, cellulose, etc., may be employed. Simply, any rigid or semi-rigid material may be used to construct the apparatus 30, 66 of the invention. In one contemplated embodiment, the apparatus 30, 66 may be made from a transparent plastic material. This material is suitable for the invention because the invention will be less visible when in use. In addition, transparent or translucent materials are believed to be more commercially viable since they are expected to appeal to a wider consumer audience, as these types of materials will be most likely to cooperate with the user's décor.

Of course, as should be appreciated by those skilled in the art, the invention may be practiced with colored materials, whether opaque, transparent, or translucent. It is intended, therefore, that these variations also fall within the scope of the invention.

With respect to the omission or addition of one or more reinforcing webs 96 to the apparatus 30, 66, the material employed to manufacture the apparatus 30, 66 is likely to dictate if one or more reinforcing webs 96 are needed. As also should be appreciated by those skilled in the art, the size of the apparatus 30, 66 also will contribute to the addition or omission of one or more reinforcing webs 96.

In one contemplated embodiment of the invention, the apparatus is made from a rigid, transparent, plastic material. In this contemplated embodiment, the apparatus 30, 66 is not likely to include one or more reinforcing webs 96. In another contemplated embodiment, the apparatus 30, 66 may be made from a flexible rubber or silicone material. In such a case, one or more reinforcing webs 96 may be required. As should be appreciated by those skilled in the art, if the material is such that it may collapse or compress upon the application of a force thereto, the reinforcing webs 96 may be needed to assure structural integrity when a compressive force is applied thereto.

FIG. 12 illustrates a third embodiment of the invention. This third embodiment is a variation on the second embodiment illustrated in FIGS. 8-11. Here, the apparatus 98 includes one or more feet 100 affixed to the bottom surface 94. The apparatus 98 is intended to be the same as the apparatus 66, except that the feet 100 are added. For this reason, the apparatus is provided with reference number 98. The feet 100 may be made from any suitable material. However, it is contemplated that the feet 100 will be made from a rubber material or a suitable equivalent. This particular embodiment is contemplated for use in environments where the floor 12 is a smooth surface, such as a tile or linoleum floor. Rubber feet 100 are expected to reduce the tendency of the apparatus 30, 66 to slide when the foot pedal 20 on the waste receptacle 10 is depressed. While three feet 100 are illustrated, the apparatus 98 may include a greater or a smaller number without departing from the scope of the invention.

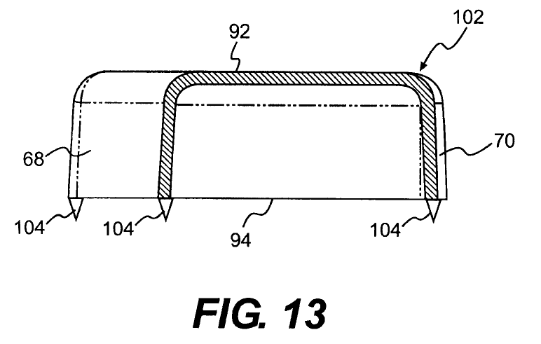

FIG. 13 illustrates a fourth embodiment of the invention. This embodiment is a further variation of the apparatus 66. Here, the apparatus is designated by the reference number 102. The apparatus 102 differs from the apparatus 66 in that projections 104 have been added to the bottom surface 94. The projections 104 are added for instances where the waste receptacle 10 is placed in a carpeted environment. The projections 104 are intended to engage the piles of the carpeting to further secure the apparatus 102 in place. While three projections 104 are illustrated, a greater or a fewer number may be employed without departing from the scope of the invention.

Additional embodiments of the invention will now be discussed in connection with FIGS. 14-29.

FIG. 14 illustrates a fifth embodiment of the invention. In this embodiment, the apparatus 106 includes a first side 108 and a second side 110. The first side 108 defines a first contact point 112 and a second contact point 114. The second side 110 defines a third contact point 116 and a fourth contact point 118. As in the prior embodiments, the first and second contact points 112, 114 are intended to engage a waste receptacle 10. As in the prior embodiments, the third and fourth contact points 116, 118 are intended to engage an immovable object such as the wall 14. In this embodiment, the distance between the first and second contact points 112, 114 is less than the distance between the third and fourth contact points 116, 118.

FIG. 15 illustrates a sixth embodiment of the invention. In this embodiment, the apparatus 120 includes a first side 122 and a second side 124. The first side 122 defines a first contact point 126 and a second contact point 128. The second side 124 defines a third contact point 130 and a fourth contact point 132. Like the prior embodiments, the first and second contact points 126, 128 are intended to engage a waste receptacle 10. As in the prior embodiments, the third and fourth contact points 130, 132 are intended to engage an immovable object such as the wall 14. In this embodiment, the distance between the first and second contact points 126, 128 is the same as the distance between the third and fourth contact points 130, 132.

FIG. 16 illustrates a seventh embodiment of the invention. In this embodiment, the apparatus 134 includes a first side 136 and a second side 138. The first side 136 defines a first contact point 140 and a second contact point 142. The second side 138 defines a third contact point 144 and a fourth contact point 146. As in the prior embodiments, the first and second contact points 140, 142 are intended to engage a waste receptacle 10. As in the prior embodiments, the third and fourth contact points 144, 146 are intended to engage an immovable object such as the wall 14. In this embodiment, the distance between the first and second contact points 140, 142 is less than the distance between the third and fourth contact points 144, 146.

FIG. 17 illustrates an eighth embodiment of the invention. In this embodiment, the apparatus 148 includes a first side 150 and a second side 152. The first side 150 defines a first contact point 154 and a second contact point 156. The second side 152 defines a third contact point 158 and a fourth contact point 160. As in the prior embodiments, the first and second contact points 154, 156 are intended to engage a waste receptacle 10. As in the prior embodiments, the third and fourth contact points 158, 160 are intended to engage an immovable object such as the wall 14. In this embodiment, the distance between the first and second contact points 154, 156 is less than the distance between the third and fourth contact points 158, 160.

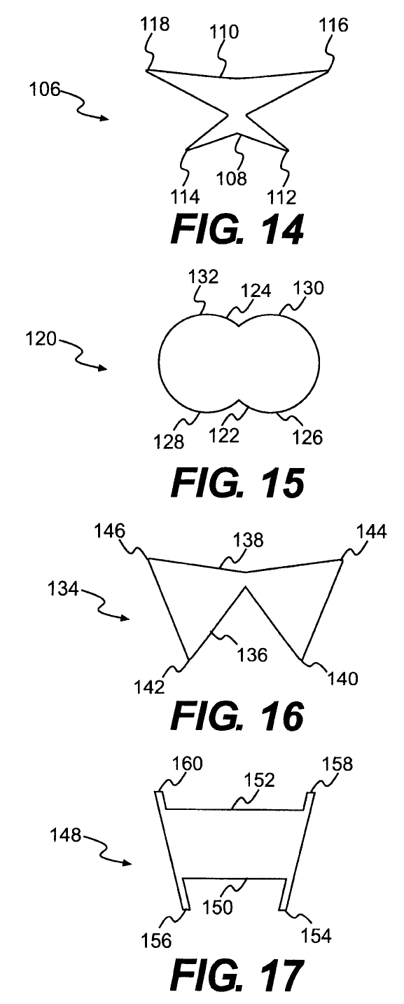

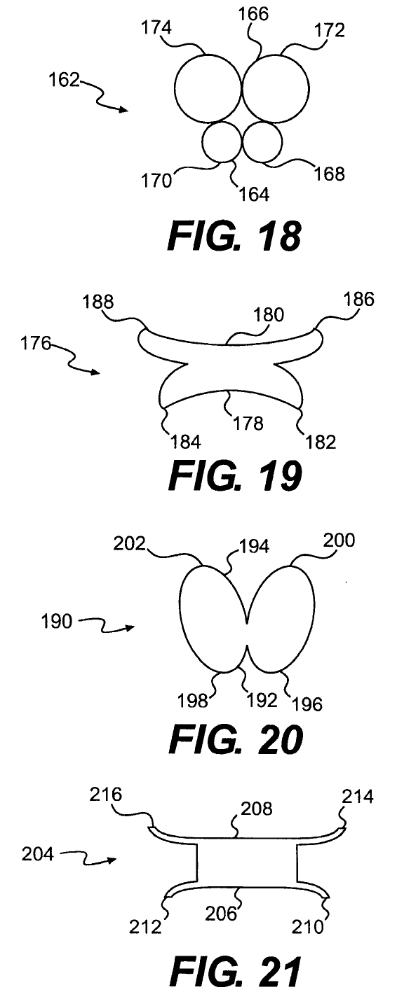

FIG. 18 illustrates a ninth embodiment of the invention. In this embodiment, the apparatus 162 is essentially the combination of four rings. The apparatus 162 includes a first side 164 and a second side 166. The first side 164 defines a first contact point 168 and a second contact point 170. The second side 166 defines a third contact point 172 and a fourth contact point 174. As in the prior embodiments, the first and second contact points 168, 170 are intended to engage a waste receptacle 10. As in the prior embodiments, the third and fourth contact points 172, 174 are intended to engage an immovable object such as the wall 14. In this embodiment, the distance between the first and second contact points 168, 170 is less than the distance between the third and fourth contact points 172, 174.

FIG. 19 illustrates a tenth embodiment of the invention. In this embodiment, the apparatus 176 includes a first side 178 and a second side 180. The first side 178 defines a first contact point 182 and a second contact point 184. The second side 180 defines a third contact point 186 and a fourth contact point 188. As in the prior embodiments, the first and second contact points 182, 184 are intended to engage a waste receptacle 10. As in the prior embodiments, the third and fourth contact points 186, 188 are intended to engage an immovable object such as the wall 14. In this embodiment, the distance between the first and second contact points 182, 184 is less than the distance between the third and fourth contact points 186, 188.

FIG. 20 illustrates an eleventh embodiment of the invention. In this embodiment, the apparatus 190 includes a first side 192 and a second side 194. The first side 192 defines a first contact point 196 and a second contact point 198. The second side 194 defines a third contact point 200 and a fourth contact point 202. As in the prior embodiments, the first and second contact points 196, 198 are intended to engage a waste receptacle 10. As in the prior embodiments, the third and fourth contact points 200, 202 are intended to engage an immovable object such as the wall 14. In this embodiment, the distance between the first and second contact points 196, 198 is less than the distance between the third and fourth contact points 200, 202.

FIG. 21 illustrates a twelfth embodiment of the invention. In this embodiment, the apparatus 204 includes a first side 206 and a second side 208. The first side 206 defines a first contact point 210 and a second contact point 212. The second side 208 defines a third contact point 214 and a fourth contact point 216. As in the prior embodiments, the first and second contact points 210, 212 are intended to engage a waste receptacle 10. As in the prior embodiments, the third and fourth contact points 214, 216 are intended to engage an immovable object such as the wall 14. In this embodiment, the distance between the first and second contact points 210, 212 is less than the distance between the third and fourth contact points 214, 216.

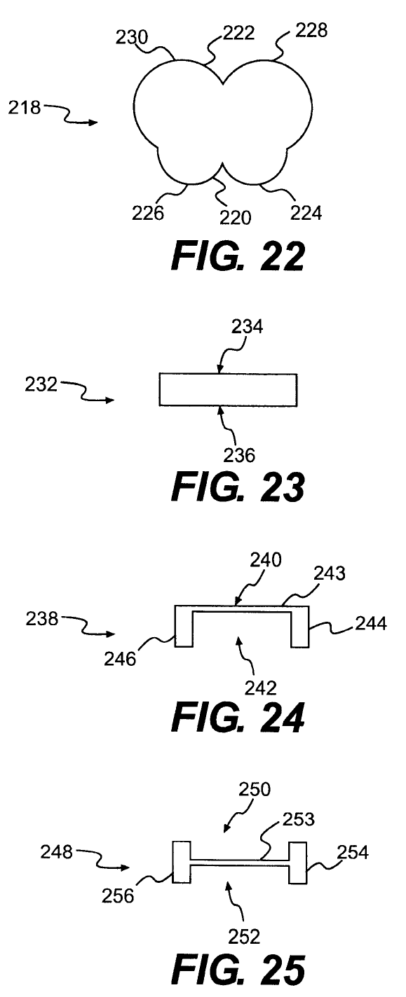

FIG. 22 illustrates a thirteenth embodiment of the invention. In this embodiment, the apparatus 218 includes a first side 220 and a second side 222. The first side 220 defines a first contact point 224 and a second contact point 226. The second side 222 defines a third contact point 228 and a fourth contact point 230. As in the prior embodiments, the first and second contact points 224, 226 are intended to engage a waste receptacle 10. As in the prior embodiments, the third and fourth contact points 228, 230 are intended to engage an immovable object such as the wall 14. In this embodiment, the distance between the first and second contact points 224, 226 is less than the distance between the third and fourth contact points 228, 230.

FIGS. 23-38 provide cross-sectional side views of various other embodiments of the invention. These embodiments are intended to cooperate with others of the embodiments described herein. Specifically, any of a wide variety of cross-sections may be employed by the various embodiments of the apparatus of the invention. As should be appreciated by those skilled in the art, the invention is not limited to any one particular cross-section.

FIG. 23 illustrates a fourteenth embodiment of the invention. This embodiment of the apparatus 232 is presented as a cross-sectional side view. In this embodiment, the apparatus 232 is a solid structure. For points of reference, the top surface is designated as 234 and the bottom surface is designated as 236. As noted above, this solid construction may be applied to any of the embodiments of the invention described herein.

FIG. 24 illustrates a fifteenth embodiment of the invention. In this embodiment, the apparatus 238 includes one or more legs 244, 246 that may be provided at the locations of the first, second, third, and fourth contact points. In other words, unlike the apparatuses 30, 66, the apparatus 238 does not have a continuous wall about the periphery of the body 243. This embodiment illustrates that a continuous periphery (i.e., continuous first, second, third, and fourth walls) are not required to practice the invention.

FIG. 25 illustrates a sixteenth embodiment of the invention. In this illustration, the apparatus 248 is similar to the apparatus 238. For reference, the top surface 240 and the bottom surface 242 of the apparatus 248 are designated. Also shown are legs 254 and 256. As may be appreciated by those skilled in the art, legs 254, 256 may not be provided. Instead, the periphery of the apparatus 248 may have a continuous wall with the body 253 being disposed at an intermediate position between the top and the bottom of the apparatus 248, as illustrated.

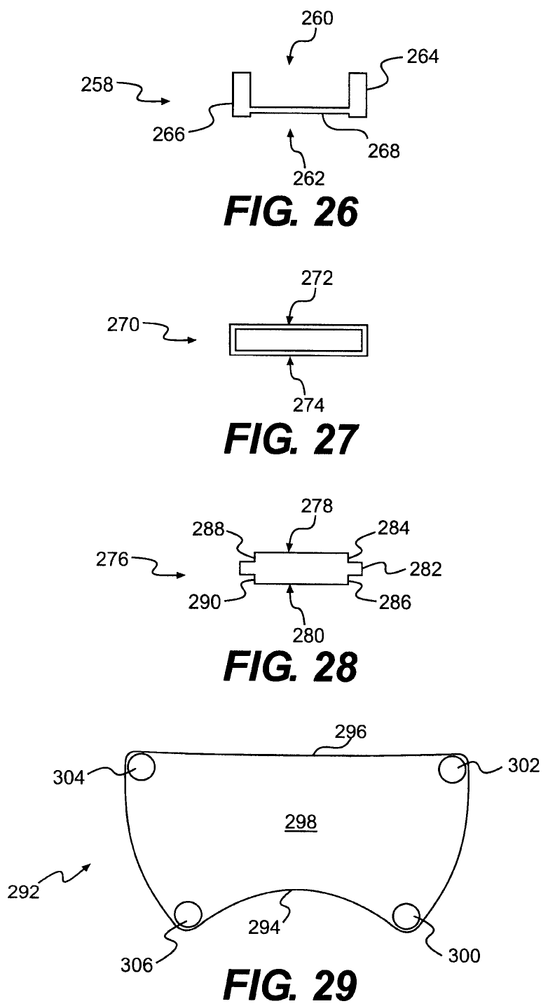

FIG. 26 illustrates a seventeenth embodiment of the invention. In this embodiment, the apparatus 258 includes a top surface 260 and a bottom surface 262. As in prior embodiments, the apparatus 258 includes legs 264, 266 that are positioned at predetermined positions about the periphery of the body 268. As noted above, the legs 264, 266 may not be employed. Instead, a continuous wall may extend around the periphery of the body 268, with the body 268 being disposed at a vertical position just above the bottom of the apparatus 258.

FIG. 27 illustrates an eighteenth embodiment of the invention. In this embodiment, the apparatus 270 includes a top surface 272 and a bottom surface 274. The apparatus 270 is illustrated as a hollow body.

FIG. 28 illustrates a nineteenth embodiment of the invention. In this embodiment, the apparatus 276 also has a top surface 278 and a bottom surface 280. For the apparatus 276, a peripheral projection 282 is provided to encircle the body of the apparatus 276. As shown, with this construction, there are four notches 284, 286, 288, 290 that are created in the cross-sectional view. While the body of the apparatus 276 is shown as a solid body, other variations are contemplated to fall within the scope of the invention.

FIG. 29 illustrates a twentieth embodiment of the invention. In this embodiment, the apparatus 292 includes a body 298 with a first surface 294 and a second surface 296, which are defined consistently with other embodiments described herein. Four legs 300, 302, 304, 306 are positioned at each of the first, second, third, and fourth contact points. This construction is consistent with variations on the embodiments illustrated in FIGS. 24-26, discussed above.

As may be appreciated by those skilled in the art, one or more features of the many embodiments discussed herein may be combined in ways too many to discuss in detail here.

As noted above, those skilled in the art should readily appreciate that there are equivalents and variations of the embodiments discussed above that may be practiced while remaining within the scope of the instant invention. Those equivalents and embodiments are intended to be encompassed hereby.

What is claimed is:

1. An apparatus for positioning a movable object with respect to an immovable object, comprising:
a body defining a top surface and a bottom surface;
a first surface extending between the top surface and the bottom surface for engaging the movable object;
a second surface extending between the top surface and the bottom surface for engaging the immovable object, the second surface being opposed to the first surface;
at least first and second contact points defined by the first surface;
at least third and fourth contacts points defined by the second surface;
wherein the first and second contact points are separated from one another by a first distance,
wherein the third and fourth contact points are separated from one another by a second distance, and
wherein the first distance is less than or equal to the second distance, thereby discouraging skewing of the body when forces of disproportionate magnitudes are applied to the first and second contact points.

2. The apparatus of claim 1, wherein the first distance is less than the second distance.

3. The receptacle positioning apparatus of claim 1, wherein:
the first and second contact points define lateral endpoints of the first surface; and
the third and fourth contact points define lateral endpoints of the second surface.

4. The receptacle positioning apparatus of claim 1, further comprising:
a third surface extending between the first surface, the second surface, the top surface, and the bottom surface; and
a fourth surface extending between the first surface, the second surface, the top surface, and the bottom surface.

5. The receptacle positioning apparatus of claim 1, wherein the first and second surfaces are curved inwardly toward a first centerline defined therebetween.

6. The receptacle positioning apparatus of claim 4, wherein the third and fourth surfaces are curved outwardly from a second centerline defined therebetween.

7. The receptacle positioning apparatus of claim 1, wherein the immovable object is a waste receptacle and the immovable object is an opposing surface.

8. The receptacle positioning apparatus of claim 7, wherein the opposing surface is a wall.

9. The receptacle positioning apparatus of claim 1, wherein the body is hollow in cross-section.

10. The receptacle positioning apparatus of claim 1, wherein the body is U-shaped in cross-section.

11. The receptacle positioning apparatus of claim 1, wherein the body is H-shaped in cross-section.

12. The receptacle positioning apparatus of claim 1, wherein the body is solid in cross-section.

13. The receptacle positioning apparatus of claim 1, further comprising:
at least one projection disposed on the bottom surface of the body.

14. The receptacle positioning apparatus of claim 13, wherein the at least one projection is conically-shaped.

15. The receptacle positioning apparatus of claim 14, wherein the at least one projection is adapted to releasably engage piles of a carpet.

16. The receptacle positioning apparatus of claim 1, further comprising:
at least one foot disposed on the bottom surface of the body.

17. The receptacle positioning apparatus of claim 16, wherein the at least one foot comprises an elastomeric material.

18. The receptacle positioning apparatus of claim 17, wherein the elastomeric material is rubber.

19. A spacer adapted to be disposed between a waste receptacle and a wall, comprising:
a body defining a top surface and a bottom surface;
a first surface extending between the top surface and the bottom surface;
at least a first contact point and a second contact point defined by the first surface, wherein the first and second contact points are for contacting the waste receptacle;
a second surface extending between the top surface and the bottom surface;
at least a third contact point and a fourth contact point defined by the second surface, wherein the third and fourth contact points for contacting the wall,
wherein the first and second contact points are separated by a first distance,
wherein the third and fourth contact points are separated by a second distance,
wherein the first distance is less than or equal to the second distance.

20. The spacer of claim 19, wherein the second distance is less than the first distance.
